(19) United States
(12) Patent Application Publication
(10) Pub. No.: US 2015/0237325 A1
(43) Pub. Date: Aug. 20, 2015

(54) METHOD AND APPARATUS FOR CONVERTING 2D IMAGES TO 3D IMAGES

(71) Applicants: INDUSTRIAL TECHNOLOGY RESEARCH INSTITUTE, Chutung, Hsinchu (TW); KARL STORZ GmbH & Co. KG, Tuttlingen (DE)

(72) Inventors: Ludovic Angot, Hsinchu City (TW); Wei-Jia Huang, Puli Township (TW); Chun-Te Wu, Taoyuan City (TW); Chia-Hang Ho, Xinfeng Township (TW)

(21) Appl. No.: 14/421,716

(22) PCT Filed: Mar. 15, 2013
(86) PCT No.: PCT/IB2013/000914

§ 371 Date: Feb. 13, 2015

Related U.S. Application Data
(60) Provisional application No. 61/683,587, filed on Aug. 15, 2012.

(51) Int. Cl. H04N 13/02; G06T 7/00

(52) U.S. Cl. CPC H04N 13/026; H04N 13/0271; H04N 13/0221; G06T 7/0071; G06T 2207/10024; G06T 2207/10012

(57) ABSTRACT

A method of converting 2D images to 3D images and system thereof is provided. According to one embodiment, the method comprises receiving a plurality of 2D images from an imaging device; obtaining motion parameters from a sensor associated with the imaging device; selecting at least two 2D images from the plurality of 2D images based on the motion parameters; determining a depth map based on the selected 2D images and the motion parameters corresponding to the selected 2D images; and generating a 3D image based on the depth map and one of the plurality of 2D images.

### RELATED APPLICATIONS

This application is based upon and claims the benefit of priority from U.S. Provisional Patent Application No. 61/683,587, filed Aug. 15, 2012, the entire contents of which are incorporated herein by reference.

### FIELD OF THE DISCLOSURE

This disclosure relates to image processing including method and apparatus for converting 2D images to 3D images.

### BACKGROUND OF THE DISCLOSURE

Imaging systems play an important role in many medical and non-medical applications. For example, endoscopy provides a minimally invasive means that allows a doctor to examine internal organs or tissues of a human body. An endoscopic imaging system usually includes an optical system and an imaging unit. The optical system includes a lens located at the distal end of a cylindrical cavity containing optical fibers to transmit signals to the imaging unit to form endoscopic images. When inserted into the human body, the lens system forms an image of the internal structures of the human body, which is transmitted to a monitor for viewing by a user.

Images generated by most existing imaging systems, such as an endoscope, are monoscopic or two-dimensional (2D). Therefore, depth information, which provides the user with a visual perception of relative distances of the structures within a scene, is not provided. As a result, it is difficult for an operator to appreciate relative distances of the structures within the field of view of the image and to conduct examinations or operations based on the 2D images.

### SUMMARY

According to some embodiments, a method of converting 2D images to 3D images is described. The method comprises receiving a plurality of 2D images from an imaging device; obtaining motion parameters from a sensor associated with the imaging device; selecting at least two 2D images from the plurality of 2D images based on the motion parameters; determining a depth map based on the selected 2D images and the motion parameters corresponding to the selected 2D images; and generating a 3D image based on the depth map and one of the plurality of 2D images.

According to some alternative embodiments, a computer-readable medium is described. The computer-readable medium comprises instructions stored thereon, which, when executed by a processor, cause the processor to perform a method for converting 2D images to 3D images. The method performed by the processor comprises receiving a plurality of 2D images from an imaging device; obtaining motion parameters from a sensor associated with the imaging device; selecting at least two 2D images from the plurality of 2D images based on the motion parameters; determining a depth map based on the selected 2D images and the motion parameters corresponding to the selected 2D images; and generating a 3D image based on the depth map and one of the selected 2D images.

According to still some alternative embodiments, a system for converting 2D images to 3D images is described. The system comprises a computer, an imaging device configured to generate a plurality of 2D images, and a sensor associated with the imaging device configured to measure motion parameters of the imaging device. The computer is configured to receive the plurality of 2D images from the imaging device; obtain the motion parameters from the sensor; select at least two 2D images from the plurality of 2D images based on the motion parameters; determine a depth map based on the selected 2D images and the motion parameters corresponding to the selected 2D images; and generate a 3D image based on the depth map and one of the selected 2D images.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1A illustrates a diagram of a system for converting 2D endoscopic images to 3D endoscopic images;

FIG. 1B illustrates a diagram of an alternative system for converting 2D endoscopic images to 3D endoscopic images;

FIGS. 2A-2C illustrate a process for determining a motion vector based on two image frames;

FIG. 3 illustrates a process of forming a 3D image based on a 2D image and a depth map corresponding to the 2D image;

FIGS. 4A-4E illustrate a process for selecting video frames to compute an optical flow and a depth map for a current image frame;

FIG. 5A illustrates a system diagram for computing a depth map for a current image frame;

FIG. 5B illustrates a process for estimating an initial depth map;

FIG. 6 illustrates an alternative process for determining a depth map based on a re-projection technique;

FIG. 7 illustrates a diagram for system calibration;

FIG. 8 illustrates a process of converting 2D images to 3D images; and

FIG. 9 illustrates a process of generating a depth map based on the 2D image frames and the position measurements.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented or stated. The implementations set forth in the following description of exemplary embodiments do not represent all implementations consistent with the disclosure. Instead, they are merely examples of systems and methods consistent with aspects related to the disclosure as recited in the appended claims. In addition, for purpose of discussion hereinafter, the terms “stereoscopic” and “3D” are interchangeable, and the terms “monoscopic” and “2D” are interchangeable.

General System Configuration

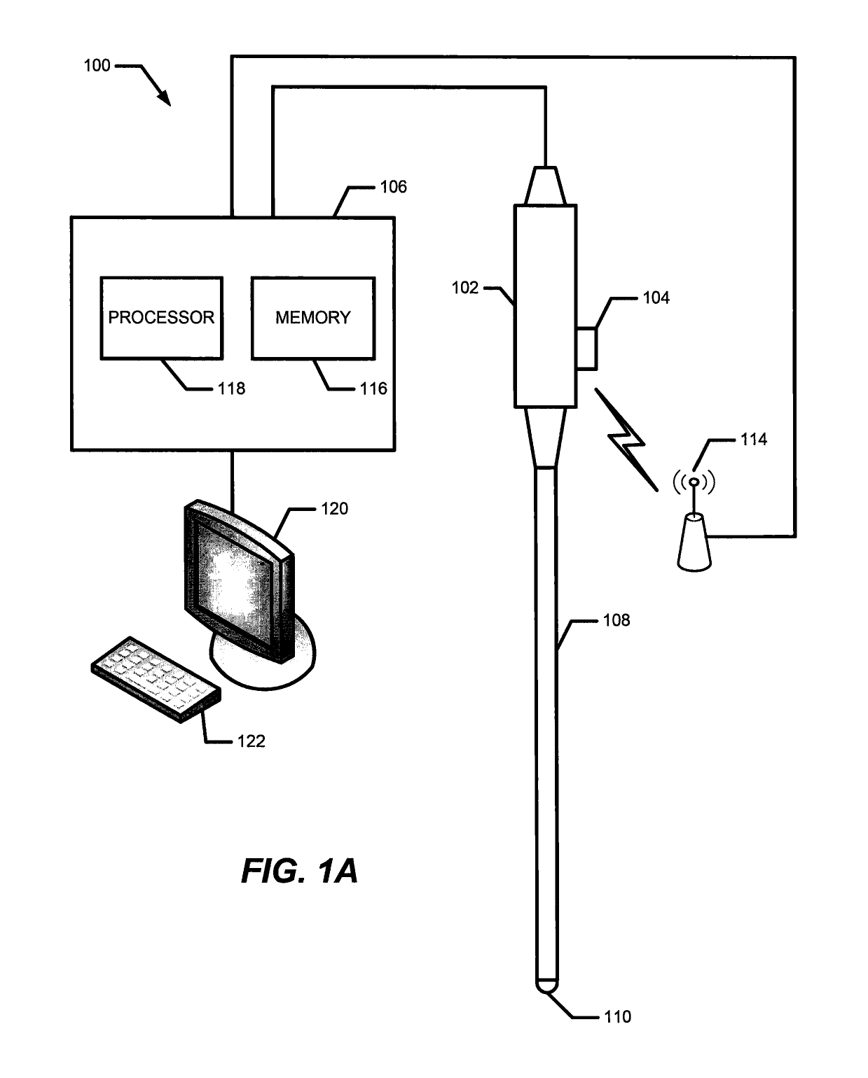

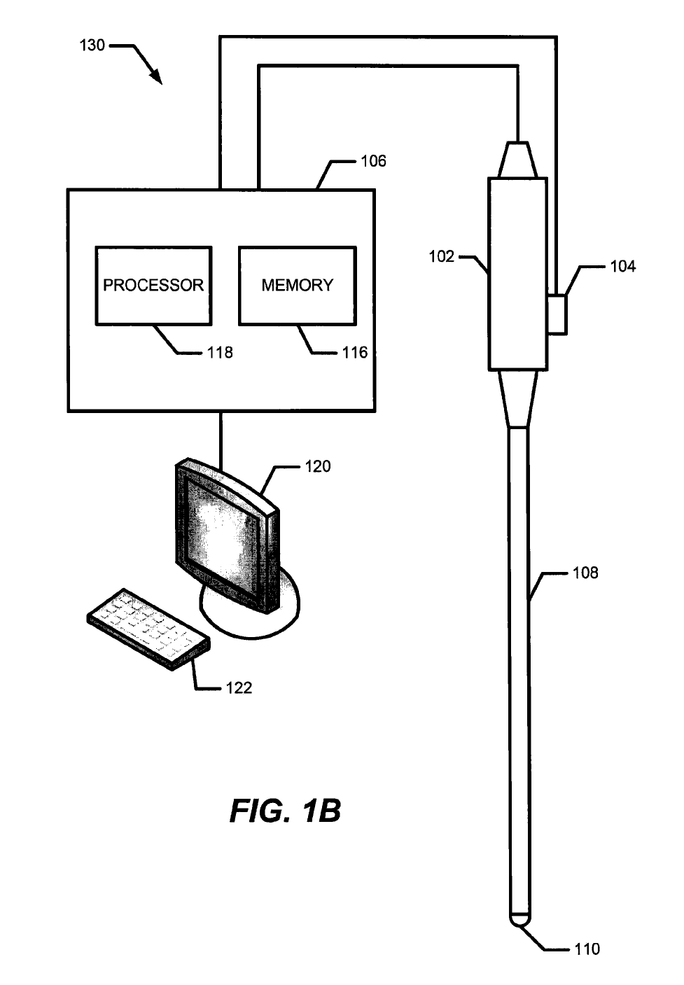

FIG. 1A illustrates a diagram of a system 100 for converting 2D images to 3D images. System 100 includes an imaging unit 102, a motion sensor 104, and a computer system 106. Imaging unit 102 may be an endoscope, including a telescope 108 and a lens system 110 attached to a distal end of telescope 108. Lens system 110 is also called a “camera” for purpose of discussion hereinafter. When inserted into a human body, lens system 110 forms images of the internal structures of the human body on an image sensor plane. The image sensor plane may be located in imaging unit 102 or lens system 110 itself. If the image sensor plane is located in imaging unit 102, the images formed by lens system 110 may be transmitted to image sensor plane through a bundle of optical fibers enclosed in telescope 108.

The images generated by imaging unit 102 are transmitted to computer system 106 via a wired connection or wirelessly via a radio, infrared, or other wireless means. Computer system 106 then displays the images on a display device, such as a monitor 120 connected thereto, for viewing by a user. Additionally, computer system 106 may store and process the digital images. Each digital image includes a plurality of pixels, which, when displayed on the display device, are arranged in a two-dimensional array forming the image.

Motion sensor 104, also called a navigation sensor, may be any device that measures its position and orientation. As shown in FIG. 1, motion sensor 104 provides position and orientation measurements with respect to a defined reference. According to one embodiment, motion sensor 104 includes a magnetic, radio, or optical transceiver, which communicates with a base station 114 through magnetic, radio, or optical signals. Motion sensor 104 or base station 114 then measures the position and orientation of motion sensor 104 with respect to base station 114. Base station 114 transmits the position and orientation measurements to computer system 106. According to one embodiment, motion sensor 104 is an absolute position sensor, which provides absolute position and orientation measurements with respect to a fixed reference.

According to an alternative embodiment shown in FIG. 1B, motion sensor 104 provides relative position and orientation measurements with respect to one of its earlier positions and orientations. Motion sensor 104 in FIG. 1B does not require a base station to measure the position and orientation and can autonomously transmit position and orientation information to computer system 106. For purpose of discussion hereinafter, motion sensor 104 and base station 114, if required, are collectively referred to as motion sensor 104.

Motion sensor 104 measures its position and orientation at regular or irregular time intervals. For example, every millisecond, motion sensor 104 measures its position and orientation and reports motion parameters indicative of the position and orientation measurements to computer system 106. The time intervals for measuring the position and orientation may be adjusted according to the motion of imaging unit 102. If imaging unit 102 has a relatively fast motion, motion sensor 104 may generate the position and orientation data at relatively small time intervals so as to provide accurate measurements. If, however, imaging unit 102 has a relatively slow motion or is stationary, motion sensor 104 may generate the position and orientation measurements at relatively large time intervals, so as to reduce unnecessary or redundant data.

Computer system 106 also includes a memory or storage device 116 for storing computer instructions and data related to processes described herein for generating 3D endoscopic images. Computer system 106 further includes a processor 118 configured to retrieve the instructions and data from storage device 116, execute the instructions to process the data, and carry out the processes for generating the 3D images. In addition, the instructions, when executed by processor 118, further cause computer system 106 to generate user interfaces on display device 120 and receive user inputs from an input device 122, such as a keyboard, a mouse, or an eye tracking device.

According to a further embodiment, imaging unit 102 generates the 2D images as video frames and transmits the video frames to computer 106 for display or processing. Each video frame of the video data includes a 2D image of a portion of a scene under observation. Computer system 106 receives the video frames in a time sequence and processes the video frames according to the processes described herein. For purpose of discussion hereinafter, the terms “video frame,” “image frame,” and “image” are interchangeable.

According to a further embodiment, computer system 106 receives the 2D images as an image sequence from imaging unit 102 and the position and orientation measurements from sensor 104 and converts the 2D images to the 3D images. The position and orientation measurements are synchronized with or correspond to the image sequence. As a result, for each video frame, computer system 106 identifies a position and orientation measurement corresponding to the video frame and determines a position and orientation of lens system 110 when the video frame is captured. To convert the 2D images to the 3D images, computer system 106 first computes an optical flow for a 2D image frame based on the video frame sequence and the position and orientation measurements and then calculates a depth map for the 2D image frame based on the optical flow and other camera parameters, such as the intrinsic parameters discussed below.

An optical flow is a data array representing motions of image features between at least two image frames generated by lens system 110. The image features may include all or part of pixels of an image frame. When the scene under observation is captured by lens system 110 from different points of view, the image features rendered in the 2D image frames move within the image plane with respect to a camera referential system. The optical flow represents motions of image features between the times at which the corresponding two image frames are captured. The optical flow may be generated based on the image frames as provided by imaging unit 102 or a re-sampled version thereof. Thus, computer system 106 determines the optical flow for an image frame based on the analysis of at least two image frames. Here, the camera referential system is a coordinate system associated with a camera center of lens system 110. The camera center may be defined as an optical center of lens system 110 or an equivalent thereof.

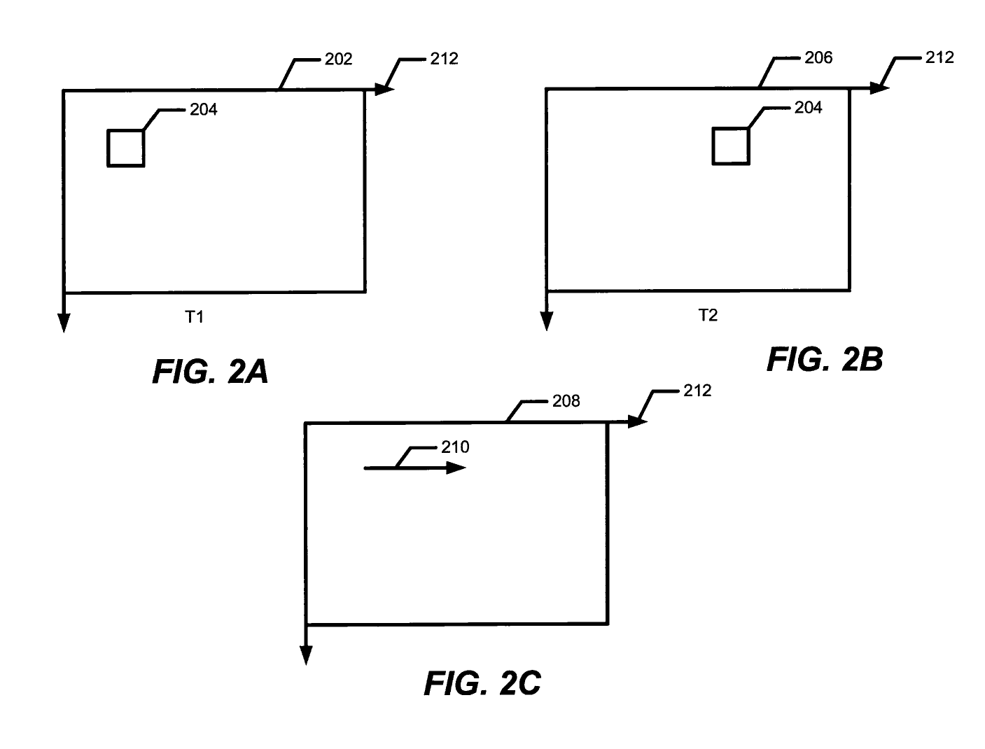

FIGS. 2A-2C illustrate one embodiment of evaluating an optical flow. As shown in FIG. 2A, lens system 110 captures an image frame 202 at time T1 having an image pattern 204 therein. Referring to FIG. 2B, at time T2, lens system captures another image frame 206, in which image pattern 204 has moved to a different location with respect to a camera referential system 212. Referring to FIG. 2C, by comparing image frames 202 and 204, computer system 106 determines an optical flow 208 for image frame 206, which includes a motion vector 210 indicating a motion of image pattern 204 from image frame 202 to image frame 206.

Further, optical flow 208 may be determined based on two or more image frames according to methods described in, for example, A. Wedel et al. “An Improved Algorithm for TV-L1 Optical Flow,” Statistical and Geometrical Approaches to Visual Motion Analysis, Vol. 5064/2008, pp. 23-45, 2009, which is hereby incorporated by reference in its entirety. Computer system 106 may also use other techniques known in the art for determining the optical flow.

Computer system 106 generates a depth map based on the calculated optical flow, and represents relative distances of the objects within a scene captured by imaging unit 102 in a corresponding image frame. Each data point of the depth map represents the relative distance of a structure or a portion thereof in the 2D image. The relative distance is defined with respect to, for example, the camera center of lens system 110.

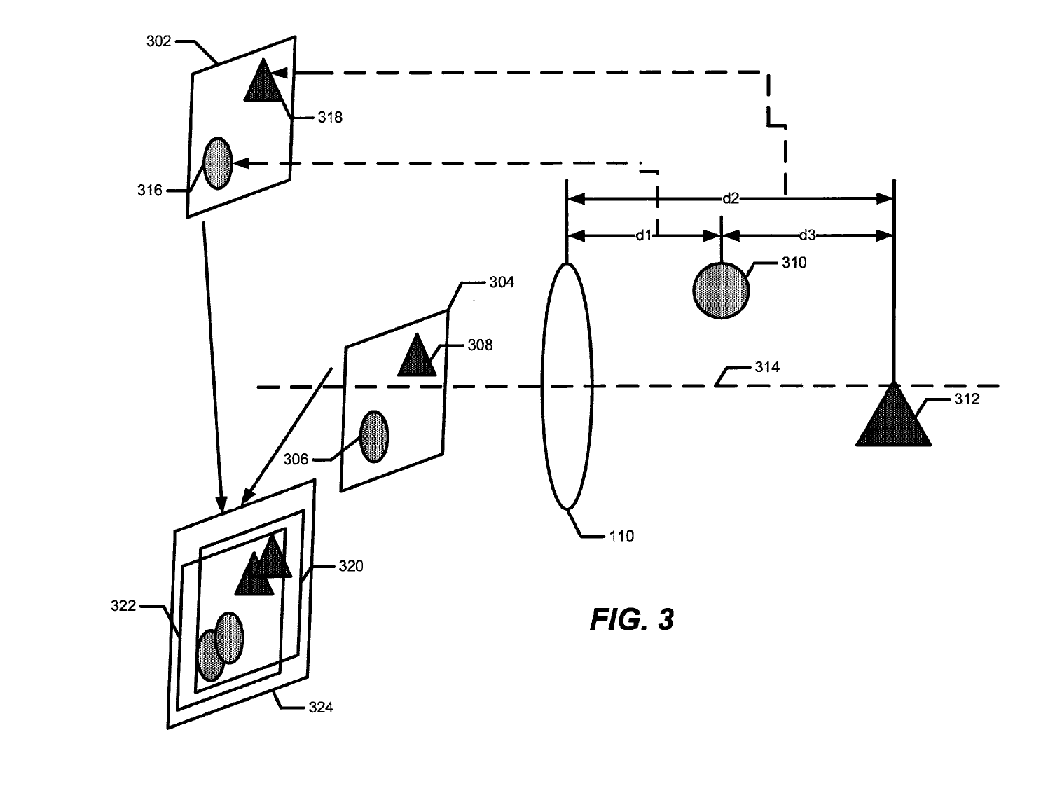

FIG. 3 illustrates a representation of a depth map 302 generated by computer system 106 corresponding to a 2D image 304 generated by lens system 110. 2D image 304 includes pixel groups 306 and 308, representing respective objects 310 and 312, or portions thereof, within a scene. Objects 310 and 312 have different depths within the scene. The depths are defined with respect to a plane including the optical center of lens system 110 and perpendicular to an optical axis 314. As a result, object 310 has a depth of d1, while object 312 has a depth of d2, as shown in FIG. 3. Depth map 302 may be coded based on a gray scale coding scheme for display to a user. For example, a relatively light gray represents a relatively small distance to the optical center, whereas a relatively dark gray represents a relatively large distance to the optical center.

Alternatively, the depths of objects 310 and 312 may be defined with respect to a position of object 310. As a result, the depth of object 310 is zero, while the depth of object 312 is a distance of d3 between objects 310 and 312. Still alternatively, depths of objects 310 and 312 may be defined with respect to any other references.

As further shown in FIG. 3, depth map 302 generated by computer system 106 is a two-dimensional data set or array including data points 316 and 318 corresponding to objects 308 and 310. Data values at data points 316 and 318 reflect the relative depths of objects 308 and 310 as defined above. Each data point of depth map 302 may correspond to a pixel of 2D image 304 or a group of pixels thereof, indicative of the relative depth of an object represented by the pixel or the group of pixels. Depth map 302 may or may not have the same size (in pixels) as 2D image 304. For example, depth map 302 may have a size smaller than image 304, in which each data point represents depth information corresponding to a group of pixels in image 304. Additionally, computer system 106 may display depth map 302 as a two-dimensional gray scale image coded with the relative depths of objects 308 and 310.

As further shown in FIG. 3, using depth map 302, computer system 106 generates a 3D image 324. For example, the 3D image 324 includes a copy 320 of image 304 and a newly created copy 322 generated based on original image 304 and depth map 302. Alternatively, computer system 106 may generate two shifted copies (320 and 322) of 2D image 304 for right and left eyes of a viewer, respectively, and integrates the two shifted 2D video frames to form a 3D video frame 324.

Computation of Optical Flow

According to an embodiment, system 100 provides a viewer or operator with a continuous and uniform stereoscopic effect. That is, the stereoscopic effect does not have any significantly noticeable variations in depth perception as the 3D images are being generated and displayed. Such consistency is ensured by a proper evaluation of the optical flow corresponding to a given amount of motion of the camera center of lens system 110. In general, the optical flow is evaluated from the 2D image frames. System 100 selects the 2D image frames to calculate the optical flow based on an amount of motion of lens system 110 and/or a magnification ratio of lens system 110.

In system 100, the scene under observation is generally stationary with respect to both the rate at which frames are captured and the motion of the lens system 110, while lens system 110 moves laterally with respect to the scene as an operator, a robotic arm, or other means of motion actuation moves lens system 110 and imaging unit 102. The relative motion between lens system 110 and the scene is determined by the motion of lens system 110 with respect to a world referential system. Here, the world referential system is a coordinate system associated with the scene or other stationary object, such as the human body under examination.

According to one embodiment, computer system 106 selects at least two image frames from the image sequence provided by imaging unit 102 to compute the optical flow. In general, computer system 106 selects the two image frames based on variation of the contents within the image frames. Because the variations of the contents within the image frames relate to the motion of lens system 110, computer system 106 monitors the motions of lens system 110 and selects the image frames based on a motion speed or a traveled distance of lens system 110 to determine which frames to select in order to compute the optical flow.

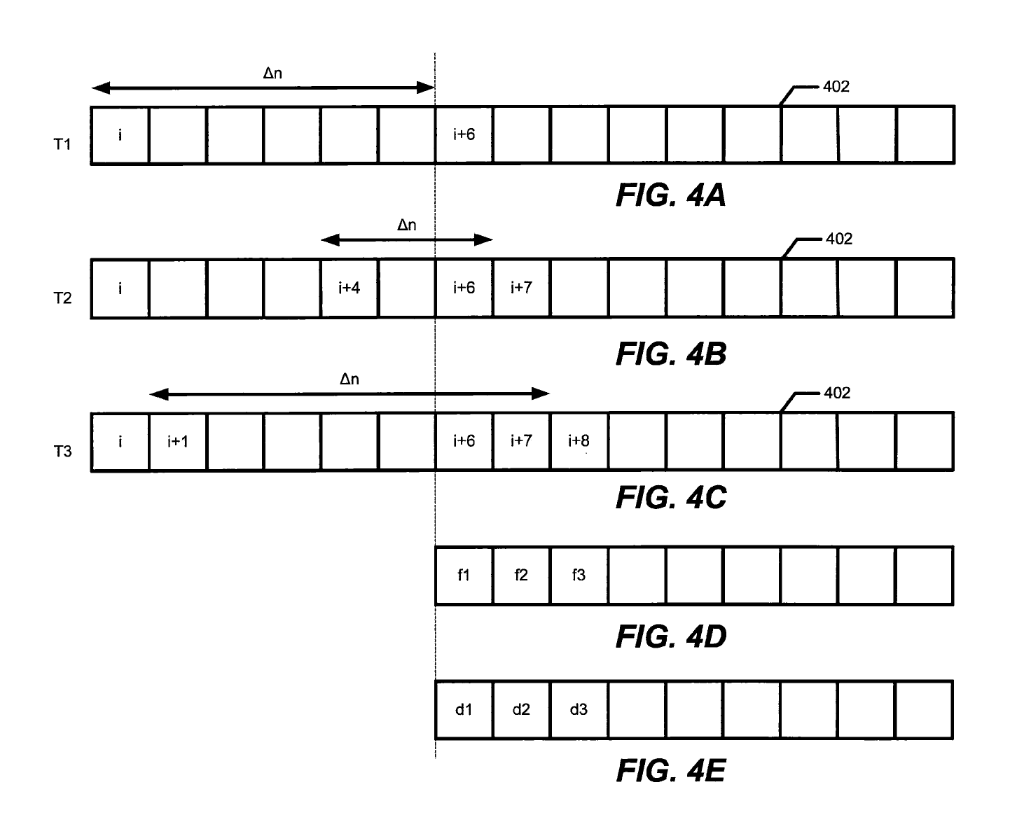

FIGS. 4A-4D illustrate a process for selecting image frames from a sequence of video frames based on the motion of lens system 110 to determine an optical flow. In particular, the number of frames intervening between the selected frames is variable, depending on an amount of motion and/or magnification ratio of lens system 110. Optical flow may not be properly determined if the motion captured by the image frame, corresponding to motion in pixels in the image frames, is too large or too small. If the motion is too large or too small, the correspondence between image features between successive image frames used for optical flow evaluation may not be established. Therefore, when lens system 110 moves at a relatively high speed with respect to the scene under observation, or when the lens system 110 has a relatively high magnification ratio, computer system 106 selects image frames close in time or with fewer intervening frames in order to ensure proper evaluation of the optical flow. When lens system 110 moves at a relatively low speed with respect to the scene or has a relatively low magnification ratio, computer system 106 selects image frames more distant in time or have a greater number of intervening frames. Adapting the number of intervening frames to the motion and/or to the magnification ratio of lens system 110 further ensures a proper computation of the optical flow.

For example, computer system 106 receives a sequence of image frames from imaging unit 102 and stores them in an image buffer 402. Image buffer 402 may be a first-in-first-out buffer or other suitable storage device as known in the art, in which image frames i, i+1, i+2 . . . are sequentially stored therein a time sequence. FIGS. 4A-4C illustrate the contents of image buffer 402 at three successive times when computer system 106 receives additional image frames, and FIG. 4D represents a time sequence of the optical flows generated based on the image frames stored in buffer 402. In FIG. 4A, computer system 106 receives frames i to i+6 from imaging unit 102 at time T1 and stores them as a time sequence in buffer 402. In FIG. 4B, computer system 106 receives an additional frame i+7 at time T2 later than time T1 and stores it at the end of the time sequence of image frames i to i+6. In FIG. 4C, computer system 106 receives an additional frame i+8 at time T3 later than time T2 and stores it in buffer 402.

Referring back to FIG. 4A, at time T1, upon receiving frame i+6 (i.e., the current frame), computer system 106 selects an earlier frame in the time sequence from buffer 402 to be compared with the current frame to determine a corresponding optical flow f1 (shown in FIG. 4D). In this particular example, computer system 106 selects image frame i, which is six frames earlier in time than the current frame, to calculate the optical flow f1.

At time T2, as shown in FIG. 4B, computer system 106 receives frame i+7, which becomes the current frame, and determines that the amount of motion of lens system 110 has increased or the magnification ratio has increased. As a result, computer system 106 selects a frame i+4, which is temporally closer to frame i+7 than frame i to frame i+6 and three frames earlier in time than the current frame, to calculate corresponding optical flow f2 (shown in FIG. 4D). Selecting a frame closer in time to the current frame ensures an appropriate optical flow to be calculated based on the selected frames.

At time T3, as shown in FIG. 4C, computer system 106 receives frame i+8, which becomes the current frame, and determines that the motion speed of lens system 110 has decreased. As a result, computer system 106 selects an earlier frame, such as frame i+1, which is seven frames earlier than the current frame, to calculate corresponding optical flow f3 (shown in FIG. 4D). Because lens system 110 moves at a lower speed at time T3 or its magnification ratio has decreased, selecting a frame more distant in time from the current frame allows for an appropriate evaluation of the optical flow.

Further, when computer system 106 determines, based on the position and orientation measurements from motion sensor 104, that lens system 110 is substantially stationary, computer system 106 does not compute a new optical flow for the current frame. This is because the 2D images generated by lens system 110 have few or no changes, and the depth map generated for a previous frame may be re-used for the current frame. Alternatively, computer system 106 may update the previous depth map using an image warping technique as described hereinafter, when lens system 110 is substantially stationary or has only a small amount of motion.

According to a further embodiment, the size of buffer 402 is determined according to a minimum motion speed for a smallest magnification ratio of lens system 110 during a normal imaging procedure. When lens system 110 travels at the minimum motion speed for a given magnification ratio, computer system 106 selects the first image frame, which corresponds to the earliest image frame available within buffer 402, to be compared with the current frame for determining the corresponding optical flow. Thus, the length of buffer 402 so determined provides a sufficient storage space to store all of the image frames that are required to calculate the optical flows at any speed greater that the minimum motion speed and at any magnification ratio greater than the smallest magnification ratio.

According to an alternative embodiment, rather than monitoring the motion speed of lens system 110, computer system 106 may select the frames to determine the optical flow based on a distance traveled by lens system 110. For example, based on the position measurements provided by motion sensor 104, computer system 106 determines a distance traveled by the lens system 110. When lens system 110 travels a relatively large distance between the prior frame and the current frame, computer system 106 selects image frames close in time or with fewer intervening frames to compute the optical flow. When lens system 110 travels a relatively small distance between the prior frame and the current frame, computer system 106 selects image frames more distant in time or with a greater number of intervening frames to compute the optical flow.

The threshold value for determining whether a new optical flow and a new depth map should be generated may be defined according to a motion speed or a travel distance of lens system 110. The threshold value may be determined empirically according to specific image procedures and may be specified in pixels of the 2D images. For example, in system 100 of FIG. 1A and system 130 of FIG. 1B, if lens system 110 travels for less than 5 pixels or has a speed less than 5 pixels per unit of time or iteration, computer 106 deems lens system 110 to be substantially stationary and re-uses the previous depth map or warps the previous depth map. The warping operation is performed by using the position and orientation measurements provided by motion sensor 104. Other threshold units, such as millimeters (mm), centimeters (cm), inches (in), etc., may also be used to determine whether the motion of the lens system 110 is substantially stationary.

According to a further embodiment, computer system 106 selects one or more regions from each of the current frame and the selected frame and computes the optical flow based on the selected regions. Computer system 106 may also compute an average motion based on the resulting optical flow and use it as an evaluation of the motion of lens system 110.

Still alternatively, computer system 106 may select the frame immediately preceding the current frame or any one of the earlier frames within buffer 402 for computing the optical flow regardless of the motion speed or the travel distance of lens system 110.

Computation of Depth Map

After the optical flow is calculated for each 2D image frame, computer system 106 determines a depth map based on a corresponding optical flow. Referring to FIG. 4E, depth maps d1, d2, d3, etc., correspond to optical flows f1, f2, f3, etc., respectively

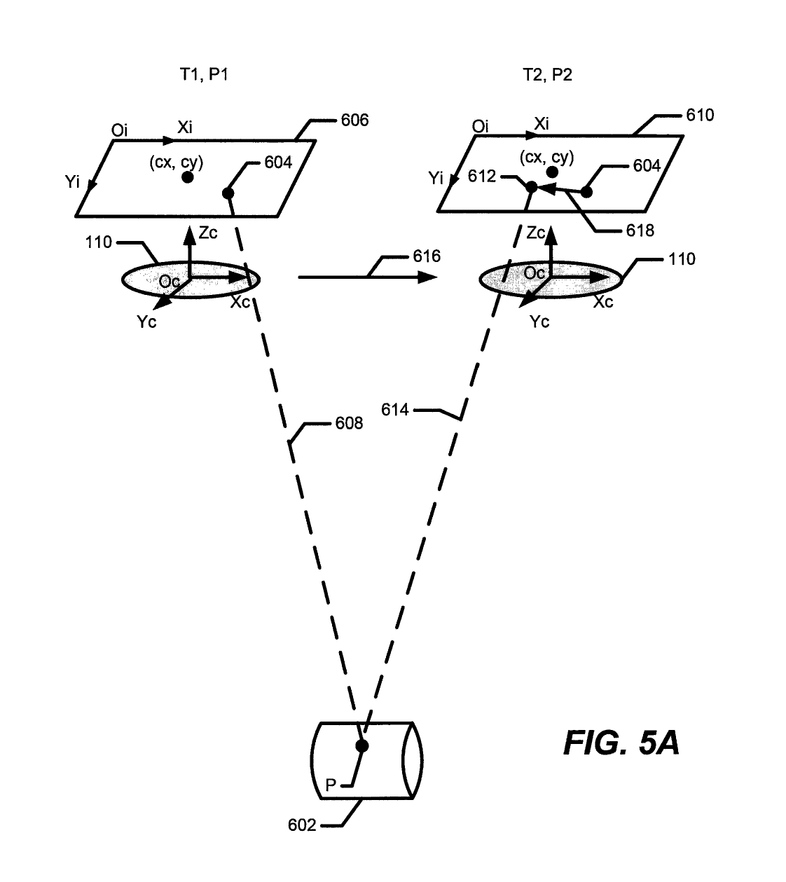

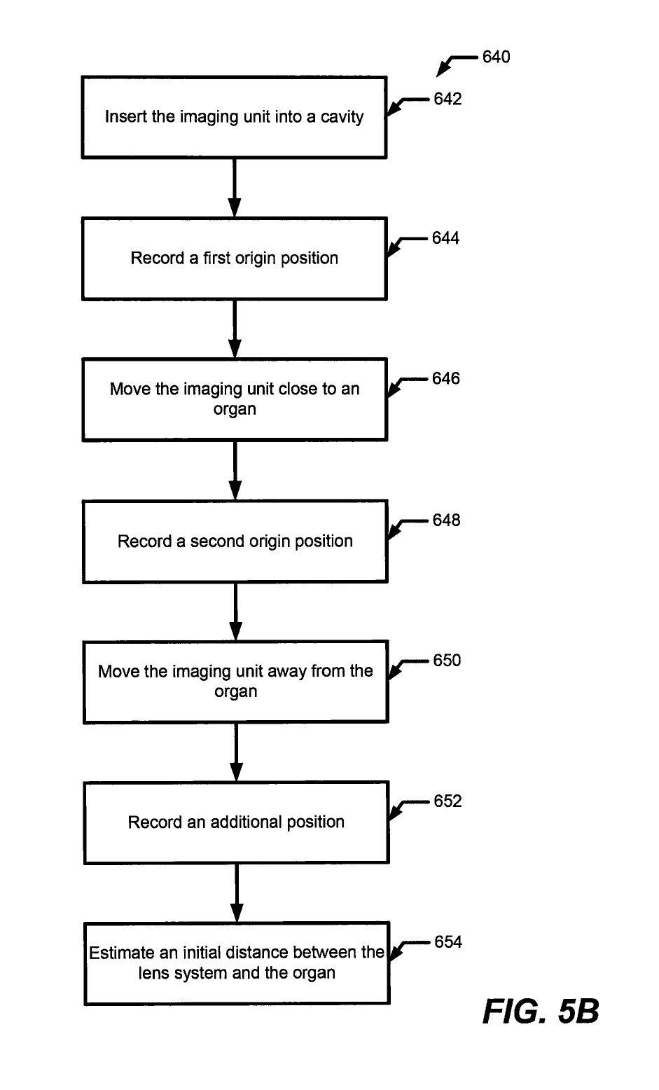

FIG. 5A depicts a process of computing a depth map based on an optical flow described above. In FIG. 5A, the image referential system associated with the image plane is defined by an image origin Oᵢ and axes Xᵢ and Yᵢ. Imaging unit 102 is modeled by a pin hole camera model and represented by a camera referential system defined by a camera origin O_{c} and camera axes X_{c}, Y_{c}, and Z_{c}. Thus, a center of image plane has coordinates of (cₓ, c_{y}), with respect to the image referential system (Xᵢ, Yᵢ), and has coordinates of (0, 0, f) with respect to the camera referential system (X_{c}, Y_{c}, Z_{c}). Symbol f represents a focal length of lens system 110 and may be obtained from a camera calibration procedure. Focal length f may be specified in, for example, pixels of the 2D images or in other units, such as mm, cm, etc.

Further in FIG. 5A, lens system 110 is at position P1 at time T1 and moves to position P2 at time T2. A point P on an object 602 is viewed through lens system 110 at position P1 and time T1. Imaging unit 102 generates an image 604 in image frame 606 through lens system 110. A location of an image pixel (i.e., image point 604) in image frame 606 is obtained by an intersection between a ray of light 608 from point P, traveling through lens system 110, and the image plane at position P1. Image point 604 is represented by coordinates (u, v) in the image referential system (Xᵢ, Yᵢ) and coordinates (u-c_{X}, v-c_{Y}, f) in the camera referential system (X_{c}, Y_{c}, Z_{c}).

The ray of light 608 may be represented by the following ray equation (1) using homogeneous coordinates:

$${r}_{1} ( {t}_{1} ) = [ \begin{matrix}\frac{x - {c}_{X}}{f} \cdot {t}_{1} \\ \frac{y - {c}_{Y}}{f} \cdot {t}_{1} \\ {t}_{1} \\ 1\end{matrix} ] , \qquad ( 1 )$$

where r₁ represents a vector function of the ray of light 608, x, y, and z are coordinates of point 604 in the camera referential system, c_{X} and c_{Y} are the coordinates of the center of the image plane defined above, f is the focal length of lens system 110 defined above, and t₁ represents a depth parameter along the ray of light 608 corresponding to image frame 606.

At time T2, when lens system 110 moves to position P2, an image frame 610 is generated by imaging unit 102 including an image point 612 of point P on object 602. Similarly, image point 612 can be modeled by an intersection between the image plane at position P2 and a ray of light 614, starting from point P on object 602 and traveling through lens system 110. In addition, the motion of image 604 of object 602 with respect to the image referential system is represented by a motion vector 618 from image point 604 to image point 612 as described above. Motion vector 618 is provided by a process described in connection with FIG. 2 and represented by (Δu, Δv), where Δu is a component of motion vector 618 along the Xᵢ axis of the image referential system and Δv is a component of motion vector 618 along the Yᵢ axis of the image referential system.

Further, at time T2 when lens system 110 travels to position P2, motion 616 of lens system 110 from position P1 to position P2 may be represented by a transformation matrix M:

$$M = [ \begin{matrix}{m}_{11} & {m}_{12} & {m}_{13} & {m}_{14} \\ {m}_{21} & {m}_{22} & {m}_{23} & {m}_{24} \\ {m}_{31} & {m}_{32} & {m}_{33} & {m}_{34} \\ 0 & 0 & 0 & 1\end{matrix} ] .$$

Computer system 106 receives position measurements from sensor 104, including, for example, translations and rotations, at times T1 and T2 and determines transformation matrix M based on the position and orientation measurements.

Hence, the ray of light 614 may be represented by the following ray equation (2) using the homogeneous coordinates:

$${r}_{2} ( {t}_{2} ) = [ \begin{matrix}\frac{x + Δ u - {c}_{X}}{f} \cdot {t}_{2} \\ \frac{y + Δ v - {c}_{Y}}{f} \cdot {t}_{2} \\ {t}_{2} \\ 1\end{matrix} ] , \qquad ( 2 )$$

where r₂ represents a vector function of the ray of light 614, t₂ represents a depth parameter along the ray of light 614 corresponding to image frame 610.

In order to simplify the notations, the following parameters are defined:

$$\frac{x - {c}_{X}}{f} = {o}_{X} , \frac{y - {c}_{Y}}{f} = {o}_{Y} , \frac{x + Δ u - {c}_{X}}{f} = {n}_{X} , \frac{y + Δ v - {c}_{Y}}{f} = {n}_{Y} .$$

Since the rays of light 608 and 614 intersect with each other at object 602, equating ray equations (1) and (2) provides solutions for depth parameters t₁ and t₂ corresponding to image frames 606 and 610, respectively. Thus, depths t₁ and t₂ may be determined from following equation (3):

$$[ \begin{matrix}{o}_{X} \cdot {t}_{1} \\ {o}_{Y} \cdot {t}_{1} \\ {t}_{1} \\ 1\end{matrix} ] = [ \begin{matrix}{m}_{11} & {m}_{12} & {m}_{13} & {m}_{14} \\ {m}_{21} & {m}_{22} & {m}_{23} & {m}_{24} \\ {m}_{31} & {m}_{32} & {m}_{33} & {m}_{34} \\ 0 & 0 & 0 & 1\end{matrix} ] \cdot [ \begin{matrix}{n}_{X} \cdot {t}_{2} \\ {n}_{Y} \cdot {t}_{2} \\ {t}_{2} \\ 1\end{matrix} ] . \qquad ( 3 )$$

Solving equation (3) provides depth t₂. Two solutions, which are substantially identical, can be found for depth t₂ as follows:

$$\begin{matrix}{t}_{2} = \frac{( {m}_{14} - {o}_{X} \cdot {m}_{34} )}{( \begin{matrix}{o}_{X} \cdot {m}_{31} \cdot {n}_{X} + {o}_{X} \cdot {m}_{32} \cdot {n}_{X} + {o}_{X} \cdot {m}_{33} - {m}_{11} \cdot \\ {n}_{X} - {m}_{12} \cdot {n}_{Y} - {m}_{13}\end{matrix} )} , & ( 4 ) \\ {t}_{2} = \frac{( {m}_{24} - {o}_{Y} \cdot {m}_{34} )}{( \begin{matrix}{o}_{Y} \cdot {m}_{31} \cdot {n}_{X} + {o}_{Y} \cdot {m}_{32} \cdot {n}_{X} + {o}_{Y} \cdot {m}_{33} - {m}_{21} \cdot \\ {n}_{X} - {m}_{12} \cdot {n}_{X} - {m}_{23}\end{matrix} )} . & ( 5 )\end{matrix}$$

In some embodiments, the results of equations (4) and (5) may be different. In particular, when there are numerical errors in system 100 due to, for example, position measurements provided by sensor 104 or computational noise, the rays of light 608 and 614 may not intersect. Accordingly, the computation of a minimum distance between the rays rather than the intersection can provide a more robust means to determine depth t₂.

According to a further embodiment, after solving for depth t₂, computer system 106 may choose to apply the solution of depth t₂ to equation (3) and solve for depth t₁ corresponding to image point 604 in image frame 606.

According to a further embodiment, computer system 106 determines the depth corresponding to each pixel of image frames 606 and 610 or a portion thereof and generates the depth maps for image frames 606 and 610. The resulting depth map and the 2D image frames 606 and 610 may have the same resolution, so that each pixel of the depth map represents a depth of a structure represented by corresponding pixels in image frames 606 or 610.

According to an alternative embodiment, system 106 may generate the depth map without using the optical flow. For example, system 106 may generate the depth map according to a method described in J. Stühmer et al., “Real-Time Dense Geometry from a Handheld Camera,” in Proceedings of the 32nd DAGM Conference on Pattern Recognition, pp. 11-20, Springer-Verlag Berlin Hedelberg 2010, which is hereby incorporated by reference in its entirety. System 100 integrates the method described by Stühmer et al. with motion sensor 104 described herein. In particular, computer system 106 receives position and orientation measurements from sensor 104 and calculates the motion of lens system 110 based on the positions measurements. Computer system 106 then uses the method described by Stühmer et al. to determine the depth map.

The method provided in Stühmer et al. is an iterative process and, thus, requires an initial estimation of the depth map. Such initial estimation may be an estimation of an average distance between objects in the scene and lens system 110. To obtain the initial estimation, computer system 106 may execute a process 640 depicted in FIG. 5B. According to process 640, at step 642, imaging unit 102 is moved to a scene. At step 644, computer system 106 records a first origin position from sensor 104 for imaging unit 102. At step 646, imaging unit 102 is moved close to an object within the scene. At step 648, computer system 106 records a second origin position from sensor 104 for imaging unit 102. At step 650, imaging unit 102 is moved away from the organ. At step 652, computer system 106 records an additional position from sensor 104 for imaging unit 102. At step 654, computer system 106 calculates an initial distance between the camera center of lens system 110 and the organ based on the position measurements collected in steps 644-652. Based on the initial distance, computer system 106 determines the initial estimation for a depth map.

According to a further embodiment, the depth map calculated by computer system 106 may not be in a proper scale for rendering a 3D image or displaying on the display device. As a result, computer system 106 may re-scale or normalize the depth map before generating the 3D image. In order to normalize a depth map, computer system 106 first determines an initial depth scale, which may be obtained using process 640 described above. Computer system 106 may then use the initial depth scale to normalize the depth map. For example, computer system 106 divides each value of the depth map by the initial depth scale and then adjusts the results so that all of the values of the normalized depth map fall within a range for proper display on display device 120.

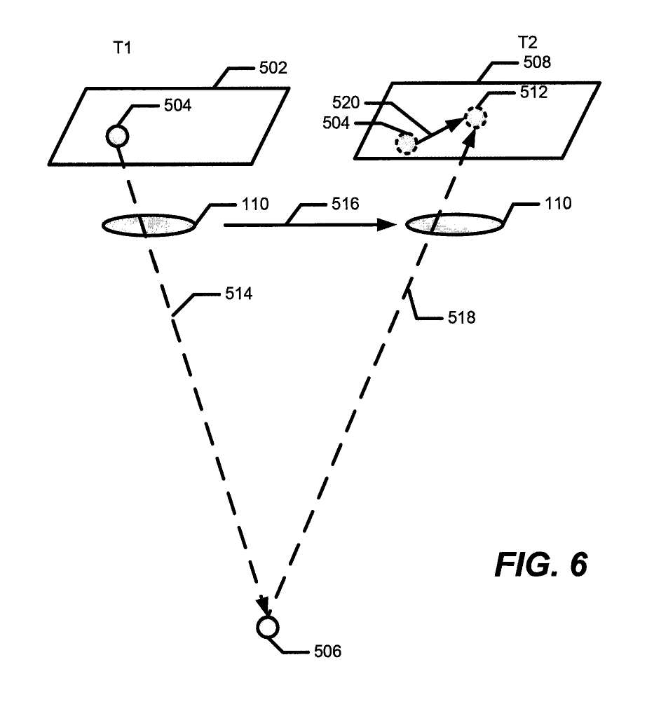

Still alternatively, computer system 106 computes the depth map by using a warping technique illustrated in FIG. 6. In particular, as shown in FIG. 6, at time T1, lens system 110 forms a first image frame 502 including an image 504 of object 506 in a scene. Thereafter, lens system 110 travels to a different position at time T2 and forms a second image frame 508. Computer system 106 applies a warping operation on the previous depth map, incorporating the position information, to generate a new depth map. Points of image frame 502 at T1 are projected onto an object space using intrinsic parameters of imaging unit 102 and the motion parameters provided by motion sensor 104. Here, the previous depth map corresponds to the image frame at time T1. When the motion of lens system 110 is small, the warping technique provides a fast means to calculate the motions of the 2D images from the motions of lens system 110.

Computer system 106 first calculates a projection 514 from image 504 to the object space and then applies a transformation 516 to the position of lens system 110. Transformation 516 between first image frame 502 and second image frame 504 can be expressed in homogenous coordinates. Computer system 106 determines transformation 516 of lens system 110 based on the position parameters provided by sensor 104. Computer system 106 then warps the previous depth map onto the new depth map as known in the art.

System Calibration

Before an imaging procedure, i.e., the computation of 3D images, is carried out, system 100 performs a system calibration. The system calibration may be performed only once, periodically, every time the system is used, or as desired by a user. The system calibration includes a camera calibration procedure and a sensor-to-camera-center calibration procedure.

The camera calibration procedure provides camera parameters including intrinsic and extrinsic parameters of lens system 110. The intrinsic parameters specify how objects are projected onto the image plane of imaging unit 102 through lens system 110. The extrinsic parameters specify a location of the camera center with respect to motion sensor 104. Camera center refers to a center of lens system 110 as known in the art. For example, camera center may be a center of an entrance pupil of lens system 110. The extrinsic parameters are used for the sensor-to-camera-center calibration. The camera calibration may be performed by computer system 106 using a camera calibration tool known in the art, such as the MATLAB camera calibration toolbox available at http://www.vision.caltech.edu/bouguet or any other camera calibration procedures or tools known in the art.

When motion sensor 104 is attached to a body of imaging unit 102, but not directly to lens system 110, motion sensor 104 provides position and orientation measurements of the body of imaging unit 102, which may be different from those of the camera center of lens system 110. The sensor-to-camera-center calibration provides a transformation relationship between the location of the motion sensor 104 attached to the body of imaging unit 102 and the camera center of lens system 110. It ensures that transformation matrix M described above is an accurate representation of the motion of the camera center of lens system 110 during the imaging procedure. The camera center of lens system 110 is a virtual point which may or may not be located at the optical center of lens system 110.

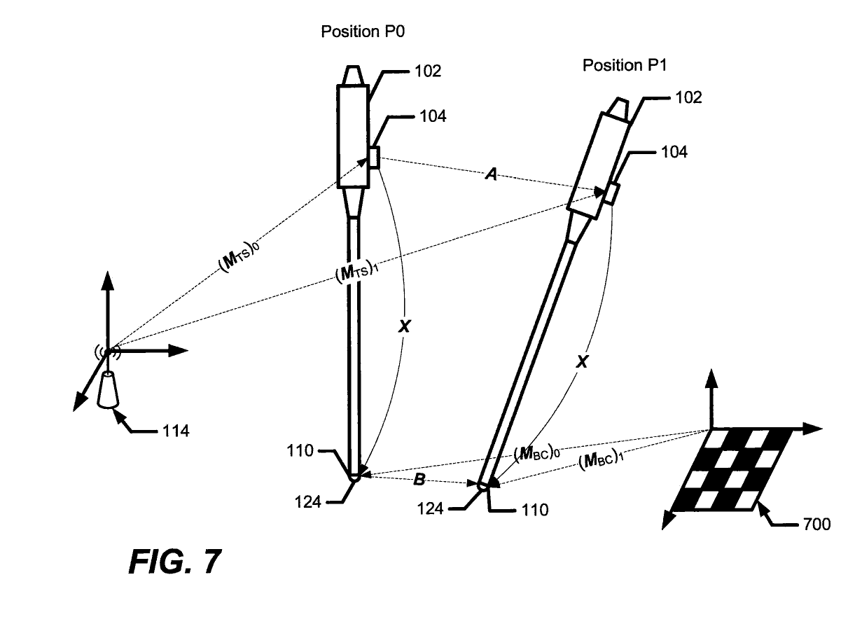

FIG. 7 depicts an exemplary process for the sensor-to-camera-center calibration procedure. The transformation relationship between motion sensor 104 and lens system 110 is represented by a transformation matrix X. During the calibration, a calibration board 700 containing black and white squares of known dimensions is presented in front of lens system 110. An image sequence of the calibration board is captured by imaging unit 102 and transmitted to computer system 106. The image sequence includes image frames corresponding to at least two different positions P0 and P1 of lens system 110. Positions P0 and P1 provide different views of calibration board 700 and include different translation and rotation motions.

Motion sensor 104 provides position and orientation measurements with respect to base station 114. At position P0, motion sensor 104 provides a position measurement represented by a transformation matrix (M_{TS})₀. In addition, based on the image frame acquired at position P0, computer system 106 determines a position of lens system 110 with respect to the calibration board represented by a transformation matrix (M_{BC})₀.

Similarly, at position P1, motion sensor 104 provides a position measurement represented by a transformation matrix (M_{TS})₁. Based on the image acquired at position P1, computer system 106 determines a position of lens system 110 with respect to the calibration board represented by a transformation matrix (M_{BC})₁.

Computer system 106 then determines a transformation matrix A of motion sensor 104 corresponding to the motion from position P0 to position P1 based on transformation matrices (M_{TS})₀ and (M_{TS})₁ as follows:

A=(M_{TS})₀⁻·(M_{TS})₁.

In addition, computer system 106 determines a transformation matrix B of a camera center 124 of lens system 110 corresponding to the motion from position P0 to position P1 based on transformation matrices (M_{BC})₀ and (M_{BC})₁ as follows:

B=(M_{BC})₀⁻¹·(M_{BC})₁.

Thus, computer system 106 determines a transformation matrix X between sensor 104 and lens system 110 by solving the following equation:

A·X=X·B.

According to a further embodiment, during sensor-to-camera-center calibration, respective paths traveled by sensor 104 and the center of lens system 110 between two successive locations of imaging unit 102 are not coplanar, in order to ensure that computer system 106 computes the matrix X properly.

According to a still further embodiment, in order to increase precision of the matrix X, multiple sets of position data of motion sensor 104 and lens system 110 are recorded. In one exemplary embodiment, 12 sets of position data of motions sensor 104 and lens system 110 are recorded during calibration. Computer system 106 then determines the results for the transformation matrix X based on the multiple sets of position data and computes the transformation matrix X by averaging the results, or minimizing an error of the result of transformation matrix X according to a least square technique.

After determining the transformation matrix X, computer system 106 stores the result in memory 116 for later retrieval during an imaging procedure and uses it to determine motions of lens system 110. In particular, referring back to FIGS. 5A and 7, at position P1, motion sensor 104 provides a position measurement (M_{TS})_{P1}, and, at position P2, motion sensor provides a position measurement (M_{TS})_{P2}. Computer system 106 then calculates the transformation 616 of lens system 110, represented by matrix M described above, using the following equation:

M=X⁻¹(Mₜₛ)_{P1}⁻¹(Mₜₛ)_{P2}X. (9)

According to one embodiment, the matrices described above are 4×4 homogeneous transformation matrices having the following form:

$$[ \begin{matrix}R & T \\ 0 & 1\end{matrix} ] ,$$

where R represents a 3×3 rotation matrix and T represents a 1×3 translation vector. One skilled in the art will recognize that non-homogeneous representations of the matrices can also be used.

Overall Imaging Process

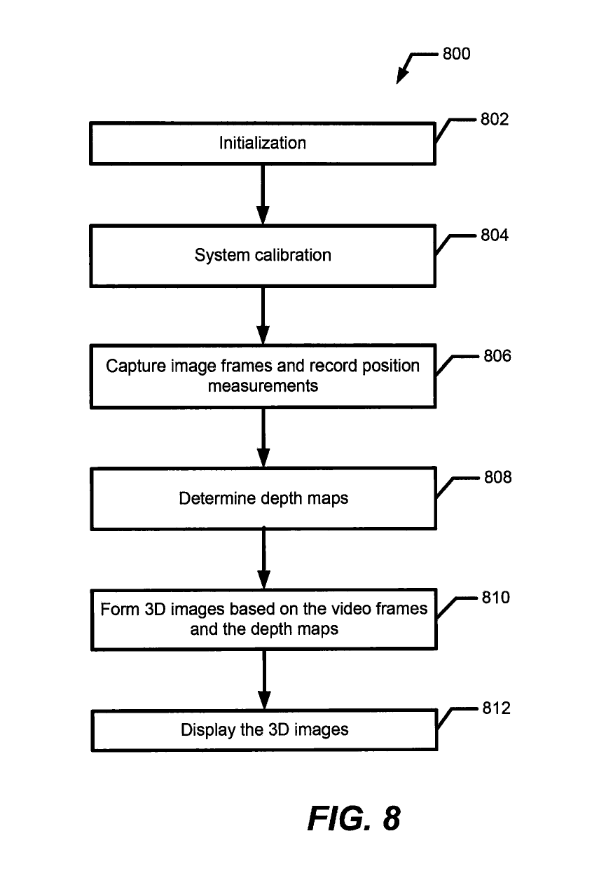

FIG. 8 depicts a process 800 for generating 3D images from 2D images using system 100, consistent with the above discussion. Process 800 may be implemented on computer system 106 through computer-executable instructions stored within memory 116 and executed by processor 118.

According to process 800, at step 802, system 100 is initialized. For example, computer system 106 receives parameters of imaging unit 102 from a user, including the focal length f of lens system 110, and stores the parameters in memory 116. During initialization, computer system 106 also prepares a memory space to establish image buffer 402 (shown in FIGS. 4A-4C).

At step 804, the system calibration is carried out, as described above in connection with FIG. 7. During the system calibration, computer system 106 determines the transformation matrix X from sensor 104 to camera center 124 of lens system 110 and stores the transformation matrix X

At step 806, computer system 106 receives image frames from imaging unit 102 and position measurements from sensor 104. Computer system 106 stores the image frames in image buffer 402 for later retrieval to calculate the depth maps. The position measurements correspond to individual image frames and specify the positions of sensor 104 with respect to the world coordinate associated with base station 114, when the individual image frames are acquired.

At step 808, computer system 106 determines depth maps based on the image frames and the position measurements received at step 806. For example, as described above in connection with FIGS. 4-6, computer system 106 selects at least two image frames to calculate an optical flow and computes the depth map based on the optical flow. Computer system 106 may select the image frames based on position measurements provided by sensor 104 as depicted in FIG. 4. Alternatively, computer system 106 may compute the depth map without using the optical flow, as described above.

At step 810, computer system 106 generates 3D images based on the 2D image frames and depth maps generated at step 808. In particular, in order to obtain a stereoscopic image, computer system 106 performs a view synthesis, transforming the 2D images and the corresponding depth maps into a pair of left and right images, interlaced images, top and bottom images, or any other suitable formats as required for a given stereoscopic display. The stereoscopic image can be displayed on an appropriate 3D display device including, for example, a head-mount device, a naked-eye viewing device, or an integral image viewing device.

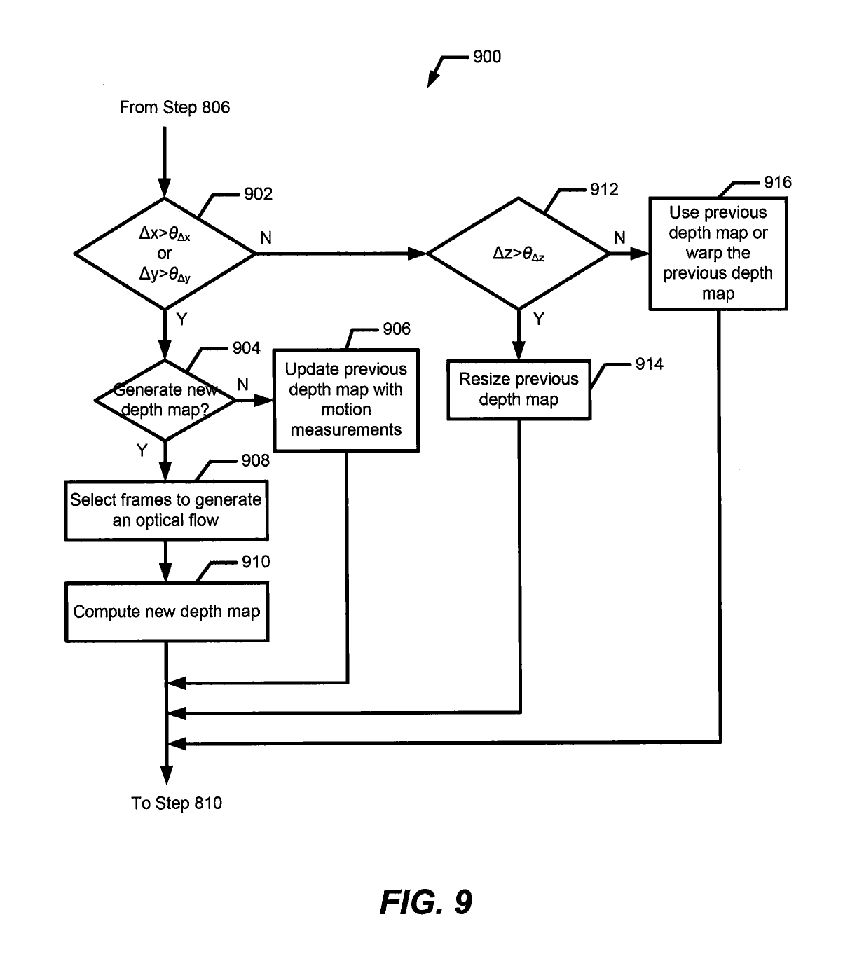

FIG. 9 depicts a process 900 conducted at step 808 for generating a depth map based on the 2D image frames and the position measurements. In particular, according to process 900, at step 902, computer system 106 determines whether lens system 110 has sufficient lateral motions required for the depth map to be generated. For example, computer system 106 checks whether the lateral motion (e.g., Δx or Δy) of lens system 110 with respect to the world referential system exceeds a respective threshold value (e.g., θ_{Δx} or θ_{Δy}). The threshold values may be, for example, specified in pixels of the 2D image frame, or any other units.

If the lateral motion exceeds the threshold value in either one of the two lateral directions (e.g., x and y directions) at step 902, computer system 106 then determines whether a new depth map should be generated (step 904). For example, if the lateral motion is relatively small even though it exceeds the threshold, a complete new depth map may still not be necessary or desired because of the computational costs required to calculate the depth map. As a result, computer system 106 determines that a new depth map is not needed and proceeds to step 906 to update a previous depth map (i.e., a depth map generated in a previous iteration) based on the position measurements provided by sensor 104. For example, computer system 106 may calculate the motion transformation matrix of camera center 124 of lens system 110 based on equation (9) using the position measurements provided by sensor 104. Based on the translation provided by the motion transformation matrix, computer system 106 may perform a shifting operation or a warping operation on the previous depth map, so that the previous depth map is updated in accordance with the motion of camera center 124 of lens system 110.

If computer system 106 determines that a new depth map is desired at step 904, computer system 106 proceeds to step 908 to select image frames in image buffer 402 to generate the new depth map. The new depth map is desired when, for example, system 100 is initialized, or lens system 110 has a significant motion, rendering the previous depth map unsuitable for the current image frame.

At step 908, computer system 106 selects at least two image frames from image buffer 402 according to the process described in connection with FIG. 4 and generates an optical flow for the current image frame.

At step 910, computer system 106 computes the new depth map based on the optical flow calculated at step 908. For example, computer system 106 first determines the transformation matrix M between the selected image frames according to the process described in connection with FIG. 7 and determines the new depth map for the current image frame according to equation (4) or (5).

Referring back to step 902, if computer system 106 determines that the lateral motions of lens system 110 are below the thresholds, computer system 106 then determines whether a longitudinal motion Δz of lens system 110 (e.g., motion along an optical axis of lens system 110) is above a threshold value (e.g., θ_{Δz}). If the longitudinal motion is above the threshold value, computer system 106 proceeds to step 914. Because the longitudinal motion of lens system 110 produces a zooming effect in the 2D image, computer system 106 determines at step 914 the depth map for the current image frame by zooming or resizing the previous depth map. Alternatively, computer system 106 applies an image warping operation to update the previous depth map.

If computer system 106 determines that the longitudinal motion Δz of lens system 110 is below the threshold value θ_{Δz}, that is, lens system 110 is substantially stationary with respect to the scene under observation, computer system 106 then re-uses the previous depth map as the depth map for the current image frame (step 916). Alternatively, at step 916, computer system 106 generates the depth map for the current image frame by warping the previous depth map. That is, when the motion of the camera center 124 remains below the thresholds defined for the x, y, and z directions, computer system 106 warps the previous depth map with the motion parameter provided by motion sensor 104 to generate the depth map for the current image frame.

After determining the depth map for the current image frame, computer system 106 proceeds to step 810 to generate the 3D image as described above.

It will be appreciated that the present disclosure is not limited to the exact construction that has been described above and illustrated in the accompanying drawings, and that various modifications and changes can be made without departing from the scope thereof. The endoscopic imaging procedure is described for illustrative purpose. The image processing techniques described herein may be used in any image display and processing system that generates 3D images from 2D images, not limited to endoscopic imaging systems. For example, it may be used in digital microscopes, video cameras, digital cameras, etc. It is intended that the scope of the disclosure only be limited by the appended claims.

What is claimed is:

1. A method of converting 2D images to 3D images, comprising:
receiving a plurality of 2D images from an imaging device;
obtaining motion parameters from a sensor associated with the imaging device;
selecting at least two 2D images from the plurality of 2D images based on the motion parameters;
determining a depth map based on the selected 2D images and the motion parameters corresponding to the selected 2D images; and
generating a 3D image based on the depth map and one of the plurality of 2D images.

2. The method of claim 1, further comprising:
generating an optical flow based on the selected 2D images.

3. The method of claim 2, further comprising:
selecting at least one image point of a first one of the selected 2D images;
projecting the at least one image point to at least one object point in an object space according to camera parameters; and
projecting the at least one object point in the object space to a second one of the selected 2D images according to the motion parameters corresponding to the second one of the selected 2D images and the camera parameters.

4. The method of claim 2, wherein the imaging device includes a lens system, the method further comprising:
determining a transformation of the lens system corresponding to the selected 2D images based on the motion parameters associated with the imaging device; and
determining the depth map additionally based on the transformation of the lens system.

5. The method of claim 4, further comprising:
determining a transformation relationship between the sensor and the lens system.

6. The method of claim 5, further comprising:
capturing at least a first 2D image and a second 2D image of a predetermined object and the motion parameters of the imaging device corresponding to the first 2D image and the second 2D image; and
determining the transformation relationship between the sensor and the lens system based on the first 2D image and the second 2D image of the predetermined object and the motion parameters corresponding to the first 2D image and the second 2D image.

7. The method of claim 1, wherein a motion of the imaging device corresponding to the selected 2D images is within a specified range.

8. The method of claim 1, further comprising:
determining a number of intervening images between the selected 2D images according to the motion parameters from the sensor.

9. The method of claim 8, further comprising:
adjusting the number of intervening frames in accordance with the motion parameters from the sensor.

10. The method of claim 1, further comprising:
determining, based on the motion parameters, a lateral motion of the imaging device with respect to a scene under observation;
comparing the lateral motion with a threshold value; and
generating a new depth map based on the selected 2D images and the motion parameters corresponding to the selected 2D images if the lateral motion exceeds the threshold value.

11. The method of claim 10, further comprising:
generating the new depth map by warping a previous depth map if the lateral motion is below the threshold value.

12. The method of claim 10, further comprising:
generating the new depth map by copying a previous depth map if the lateral motion is below the threshold value.

13. The method of claim 1, wherein a resolution of the depth map is different from a resolution of the 2D images.

14. A computer-readable medium comprising instructions stored thereon, which, when executed by a processor, cause the processor to perform a method for converting 2D images to 3D images, the method comprising:
receiving a plurality of 2D images from an imaging device;
obtaining motion parameters from a sensor associated with the imaging device;
selecting at least two 2D images from the plurality of 2D images based on the motion parameters;
determining a depth map based on the selected 2D images and the motion parameters corresponding to the selected 2D images; and
generating a 3D image based on the depth map and one of the selected 2D images.

15. The computer-readable medium of claim 14, wherein a motion of the imaging device corresponding to the selected 2D images is within a specified range.

16. The computer-readable medium of claim 14, the method further comprising:
determining a number of intervening frames between the selected 2D images according to the motion parameters from the sensor.

17. The computer-readable medium of claim 16, the method further comprising:
adjusting the number of intervening frames in accordance with the motion parameters from the sensor.

18. The computer readable medium of claim 14, the method further comprising:
determining, based on the motion parameters, a lateral motion of the imaging device with respect to a scene under observation;
comparing the lateral motion with a threshold value; and
generating a new depth map based on the selected 2D images and the motion parameters corresponding to the selected 2D images if the lateral motion exceeds the threshold value.

19. The computer-readable medium of claim 18, the method further comprising:
generating the new depth map by warping or copying a previous depth map if the lateral motion is below the threshold value.

20. A system for converting 2D images to 3D images, comprising:
an imaging device configured to generate a plurality of 2D images;
a sensor associated with the imaging device configured to measure motion parameters of the imaging device;
a computer configured to:
receive the plurality of 2D images from the imaging device;
obtain the motion parameters from the sensor;
select at least two 2D images from the plurality of 2D images based on the motion parameters;
determine a depth map based on the selected 2D images and the motion parameters corresponding to the selected 2D images; and
generate a 3D image based on the depth map and one of the selected 2D images.

21. The system of claim 20, wherein the imaging device is an endoscope.
